(19) United States
(12) Patent Application Publication
(10) Pub. No.: US 2024/0408803 A1
(43) Pub. Date: Dec. 12, 2024

(54) MOLD INSERT FOR TUBING-FORMING MOLD APPARATUSES

(71) Applicant: W. L. Gore & Associates, Inc., Newark, DE (US)

(72) Inventors: Jason T. Alger, Flagstaff, AZ (US); Lori L. Fellows, Flagstaff, AZ (US); Franklin Alex Garcia, Phoenix, AZ (US); Dale D. Mongeau, JR., Phoenix, AZ (US); Wade S. Nielsen, Phoenix, AZ (US); Danny Zuniga, Phoenix, AZ (US)

(21) Appl. No.: 18/737,088

(22) Filed: Jun. 7, 2024

Related U.S. Application Data
(60) Provisional application No. 63/471,797, filed on Jun. 8, 2023.
(60) Provisional application No. 63/531,976, filed on Aug. 10, 2023.

(51) Int. Cl. B29C 45/26; B29C 35/08; B29C 45/73

(52) U.S. Cl. CPC B29C 45/261; B29C 35/0805; B29C 45/2602; B29C 45/7337; B29C 2035/0811

(57) ABSTRACT

Molds or mold inserts are implemented or installed in a mold apparatus for forming a polymeric product such as a tubing. The mold includes an outer component and an inner component. The outer component defines a first inner cavity having a first diameter, and the inner component is disposed at least partially inside the inner cavity of the outer component. The inner component has an inner surface which defines a second inner cavity having a second diameter smaller than the first diameter. In certain examples, the inner component is a single unitary piece. In some examples, the inner component includes a first subcomponent and a second subcomponent that couple together to define the second inner cavity through which a polymeric material is configured to pass during formation of the polymeric product.

### CROSS REFERENCE TO RELATED APPLICATIONS

This application claims the benefit of U.S. Provisional Application No. 63/471,797, filed Jun. 8, 2023, and U.S. Provisional Application No. 63/531,976, filed Aug. 10, 2023, the disclosures which are incorporated by reference herein in their entireties for all purposes.

### FIELD

The present disclosure relates to apparatus for forming, molding or welding polymeric products and, more particularly, to a mold component which may be used therein.

### BACKGROUND

Plastic molding equipment for shaping/molding/welding plastic products such as plastic tubing often employ a resistive element for heating. Inductive heating systems are also commonly employed. Common mold designs with deep and narrow orifices as known in the art may limit coating material and application options.

The mold component of molding equipment is generally received in a mold assembly. If a different mold component is needed on the basis of the type of molding operation to be performed (e.g., shaping, molding, or welding) or on the basis of the configuration of product to be molded, then a separate mold component must be provided to replace the original mold component.

### SUMMARY

Disclosed herein are molds or mold inserts to be implemented or installed in a mold apparatus for forming (e.g., shaping, molding, or welding) a polymeric product such as a tubing. In some examples, the mold has a single unitary piece design. Advantageously, the single-piece design may reduce or eliminate the amount of flash or polymer flow within the seams or interface surfaces of the mold. In some examples, the mold has a multi-piece design which allows for the entire cavity within the mold to be coated with a coating material before assembling the pieces together to form the forming cavity. Advantageously, the multi-piece design simplifies the process of coating the inner surface of the cavity through which the polymeric material such as thermoplastic tubing may pass during the formation of the tubing. Such advantages may be realized by allowing the pieces of the mold to be separately and individually coated prior to assembling the pieces together to form the mold, as further explained herein. Mold release may be typically used within a molding process to ensure the release of the formed part from the mold tooling.

According to one example (“Example 1”), a mold for apparatus for forming a polymeric product includes an outer component and an inner component. The outer component defines a first inner cavity having a first diameter, and the inner component is disposed at least partially inside the first inner cavity of the outer component. The inner component has an inner surface which defines a second inner cavity having a second diameter smaller than the first diameter. The inner component is a single unitary piece comprising an inner surface that defines the second inner cavity for receiving a polymeric material during molding of the polymeric product.

According to another example (“Example 2”), a mold for apparatus for forming a polymeric product includes an outer component and an inner component. The outer component defines a first inner cavity having a first diameter, and the inner component is disposed at least partially inside the first inner cavity of the outer component. The inner component has an inner surface which defines a second inner cavity having a second diameter smaller than the first diameter. The inner component includes a first subcomponent having a first inner surface and a second subcomponent having a second inner surface. The first and second subcomponents are configured to couple together, and the first and second inner surfaces are configured to define the second inner cavity for receiving a polymeric material during molding of the polymeric product.

According to another example (“Example 3”) further to Example 2, the inner component further includes a third subcomponent having a third inner surface. The first, second, and third subcomponents are configured to couple together, and the first, second, and third inner surfaces are configured to define the second inner cavity.

According to another example (“Example 4”) further to any one of the preceding Examples, prior to coupling together to define the second inner cavity, the inner surfaces of the subcomponents of the inner component are separately and individually coated with a coating material.

According to another example (“Example 5”) further to Example 4, the coating material includes one or more of: titanium nitride, titanium carbo-nitride, titanium aluminum carbo-nitride, zirconium nitride, chromium nitride, aluminum titanium nitride, aluminum chromium and silicon, or aluminum chromium nitride.

According to another example (“Example 6”) further to any one of the preceding Examples, the outer component includes an outer elongate portion and an outer flange portion extending radially outwardly from the outer elongate portion.

According to another example (“Example 7”) further to Example 6, the outer flange portion includes a plurality of flanges, and at least one of the flanges includes a cut portion which extends less radially outwardly than other flanges.

According to another example (“Example 8”) further to Example 7, the plurality of flanges form a spool configured to support a coil for inductively heating the mold.

According to another example (“Example 9”) further to any one of Examples 6-8, the inner component includes an inner elongate portion and an inner flange portion extending radially outwardly from the inner elongate portion.

According to another example (“Example 10”) further to any one of the preceding Examples, the second inner cavity has a first end having one opening and a second end having a plurality of openings.

According to another example (“Example 11”) further to Example 10, the one opening at the first end of the second inner cavity has a larger diameter than any one of the plurality of openings at the second end.

According to another example (“Example 12”) further to Example 10 or 11, the plurality of openings at the second end have different diameters.

According to another example (“Example 13”) further to any one of Examples 10-12, the inner surface of the inner component includes a transition portion configured to transition in diameter between the first end and the second end of the second inner cavity.

According to another example (“Example 14”) further to Example 13, the transition portion includes a taper.

According to another example (“Example 15”) further to any one of the preceding Examples, at least one of the outer component or the inner component is made of one or more of: stainless steel, nitrogen-enhanced duplex stainless steel, molybdenum-type high-speed steel, nickel, or nickel-iron alloy.

According to one example (“Example 16”), a mold apparatus for forming a tubing includes the mold of any one of the preceding Examples, and also includes a housing configured to securely support the mold, a support and feed unit supported by the housing and configured to insert and withdraw a mandrel supporting the tubing into and from the mold, an air supply unit configured to provide air for cooling the mold, and a controller configured to control operation of the support and feed unit and to supply energy for heating the mold.

According to one example (“Example 17”), a method of forming a mold for an apparatus for forming a polymeric product includes: coating a first inner surface of a first subcomponent; coating a second inner surface of a second subcomponent; forming an inner component by coupling the first subcomponent with the second subcomponent to define a second inner cavity for receiving a polymeric material during molding of the polymeric product; and at least partially disposing the inner component inside a first inner cavity of an outer component.

According to another example (“Example 18”) further to Example 17, coating the first and second inner surfaces includes applying a coating material to the first and second inner surfaces.

The foregoing Examples are just that, and should not be read to limit or otherwise narrow the scope of any of the inventive concepts otherwise provided by the instant disclosure. While multiple examples are disclosed, still other embodiments will become apparent to those skilled in the art from the following detailed description, which shows and describes illustrative examples. Accordingly, the drawings and detailed description are to be regarded as illustrative in nature rather than restrictive in nature.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the disclosure.

FIGS. 1A and 1B are angled views of a mold or mold insert according to embodiments disclosed herein;

FIG. 1C is a front view of the mold;

FIG. 1D is a back view of the mold;

FIG. 1E is an angled view of the mold with an internal component removed from an external component of the mold;

FIG. 1F is an angled view of the mold with the internal component separated into two subcomponents;

FIG. 1G is an angled view of the internal component of the mold being made of a single unitary piece, according to embodiments disclosed herein;

FIG. 2A is an angled view of the external component of the mold;

FIG. 2B is a side view of the external component;

FIG. 2C is a front view of the external component;

FIG. 2D is a back view of the external component;

FIG. 3A is an angled view of the internal component of the mold;

FIG. 3B is a front view of the internal component;

FIG. 3C is a back view of the internal component;

FIG. 3D is a side view of the internal component;

FIG. 3E is an angled view of the internal component separated into two subcomponents;

FIGS. 3F and 3G are angled views of each of the subcomponents of the internal component;

FIG. 4 is a cross-sectional side view of the mold;

FIGS. 5A and 5B are back views of an internal component having three subcomponents according to embodiments disclosed herein;

FIG. 6 is a front view of the mold being incorporated into a platform or housing for the mold apparatus according to embodiments disclosed herein; and

FIG. 7 is a schematic diagram of a mold assembly implementing the mold according to embodiments disclosed herein.

### DETAILED DESCRIPTION

### Definitions and Terminology

This disclosure is not meant to be read in a restrictive manner. For example, the terminology used in the application should be read broadly in the context of the meaning those in the field would attribute such terminology.

With respect to terminology of inexactitude, the terms “about” and “approximately” may be used, interchangeably, to refer to a measurement that includes the stated measurement and that also includes any measurements that are reasonably close to the stated measurement. Measurements that are reasonably close to the stated measurement deviate from the stated measurement by a reasonably small amount as understood and readily ascertained by individuals having ordinary skill in the relevant art. Such deviations may be attributable to measurement error, differences in measurement and/or manufacturing equipment calibration, human error in reading and/or setting measurements, minor adjustments made to optimize performance and/or structural parameters in view of differences in measurements associated with other components, particular implementation scenarios, imprecise adjustment and/or manipulation of objects by a person or machine, and/or the like, for example. In the event it is determined that individuals having ordinary skill in the relevant art would not readily ascertain values for such reasonably small differences, the terms “about” and “approximately” can be understood to mean plus or minus 10% of the stated value.

### DESCRIPTION OF VARIOUS EMBODIMENTS

Persons skilled in the art will readily appreciate that various aspects of the present disclosure can be realized by any number of methods and apparatuses configured to perform the intended functions. It should also be noted that the accompanying drawing figures referred to herein are not necessarily drawn to scale, but may be exaggerated to illustrate various aspects of the present disclosure, and in that regard, the drawing figures should not be construed as limiting.

The present disclosure relates to molds or mold inserts which may be implemented or installed in a mold apparatus for forming a polymeric product such as a tubing. The mold includes an outer component and an inner component. The outer component defines a first inner cavity having a first diameter, and the inner component is disposed at least partially inside the inner cavity of the outer component. The inner component has an inner surface which defines a second inner cavity having a second diameter smaller than the first diameter. The inner component includes a first subcomponent having a first inner surface, and a second subcomponent having a second inner surface. The first and second subcomponents couple together to define the second inner cavity through which a polymeric material is configured to pass during formation of the polymeric product.

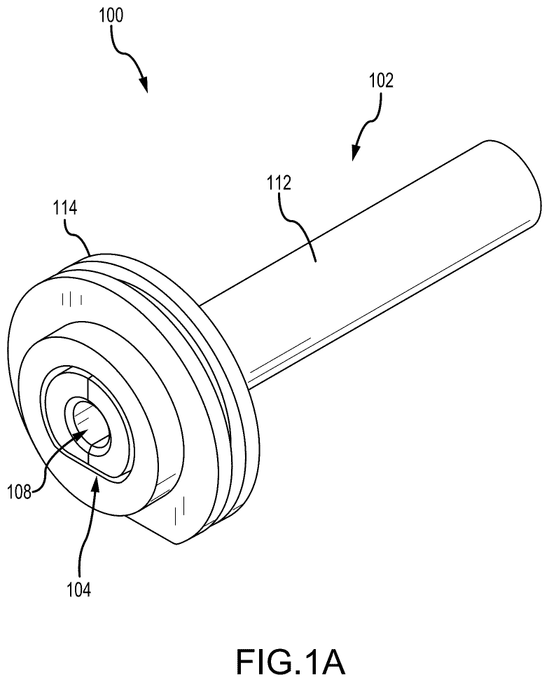

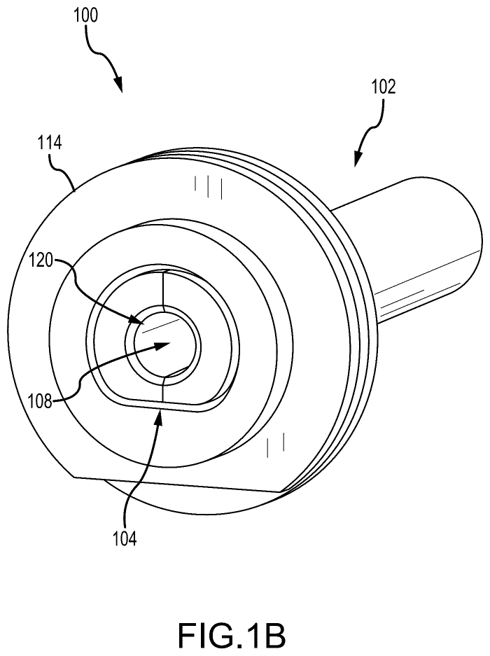

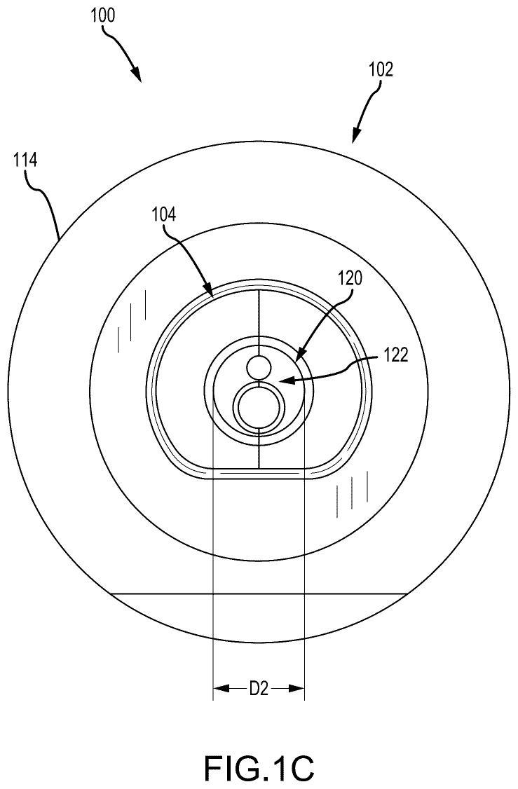

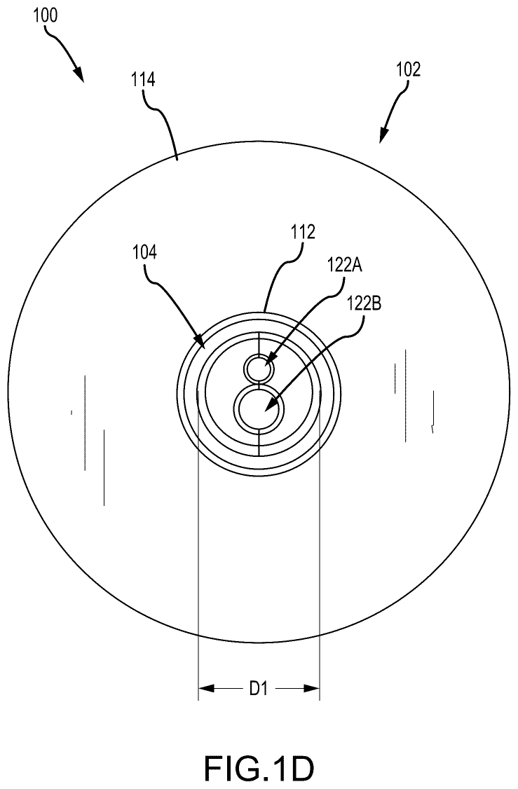

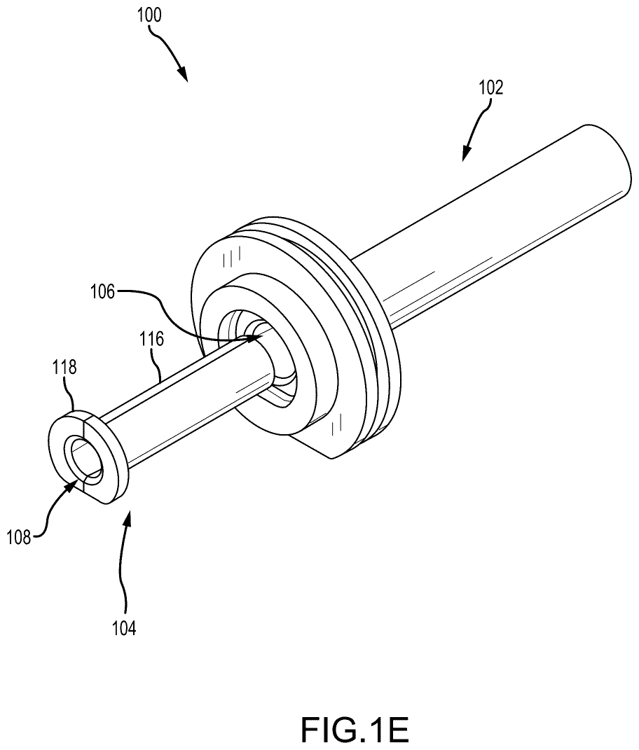

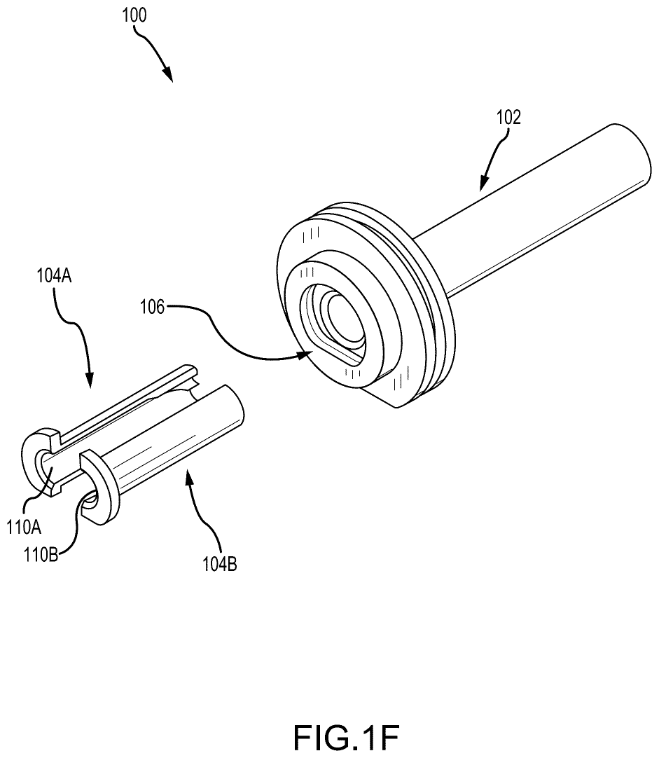

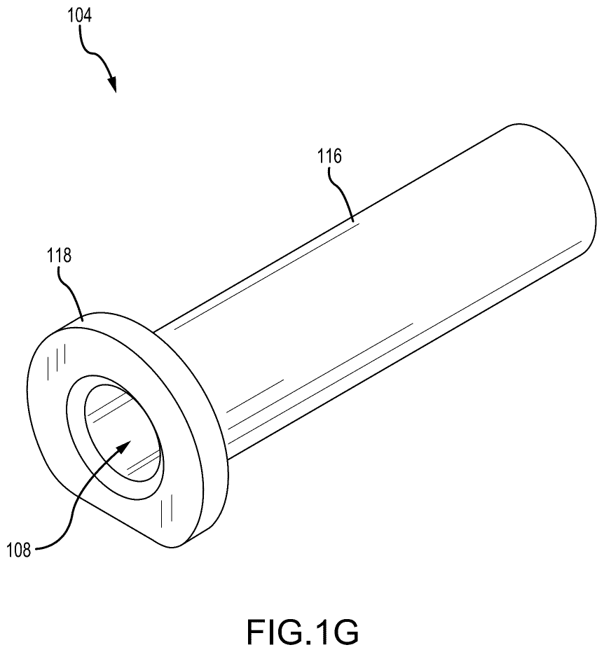

FIGS. 1A through 1F illustrate a mold 100 which includes modular pieces (e.g., separately manufactured): an outer component 102 and an inner component 104. The outer component 102 defines a first inner cavity 106 (FIG. 1E) extending through the component 102, for example through a longitudinal length of the outer component 102. The inner component 104 is disposed at least partially inside the first inner cavity 106. The inner component 104 has an inner surface 110 defining a second inner cavity 108. The first inner cavity 106 has a first width or diameter D1, and the second inner cavity 108 has a second width or diameter D2 that is smaller than the first diameter D1. The diameters D1 and D2 may be measured at the end of the respective cavities. In some examples, the widths may be referred to as diameters if the cavities are generally tubular in shape. In instances of non-circular shaped objects, the term diameter may also be used to refer to the smallest diameter circle through which an object may be passed. In some examples, the diameters may be the average diameters calculated along the entirety of the respective cavities. In some examples, the diameters may be the maximum diameters measured at any portion of the respective cavities.

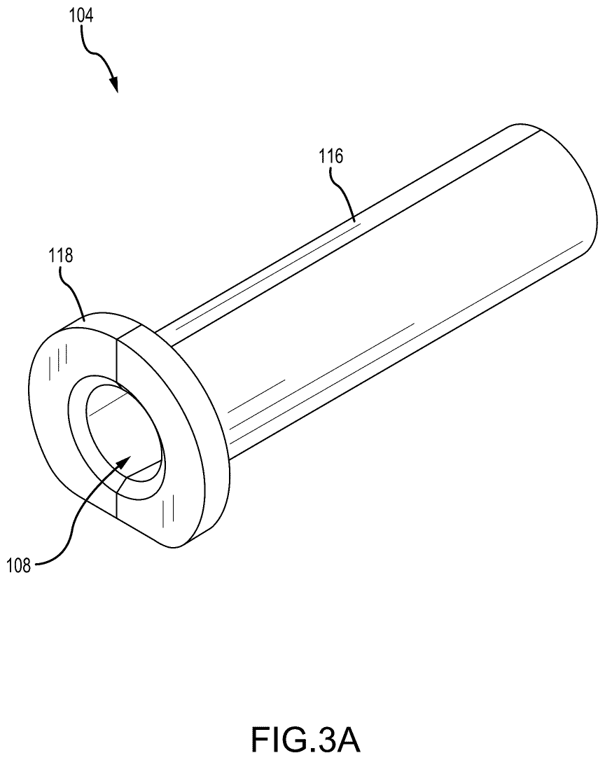

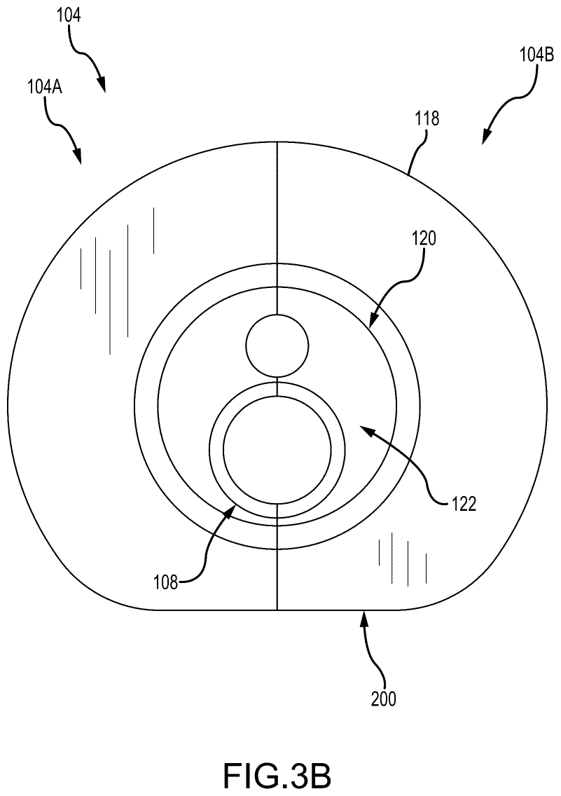

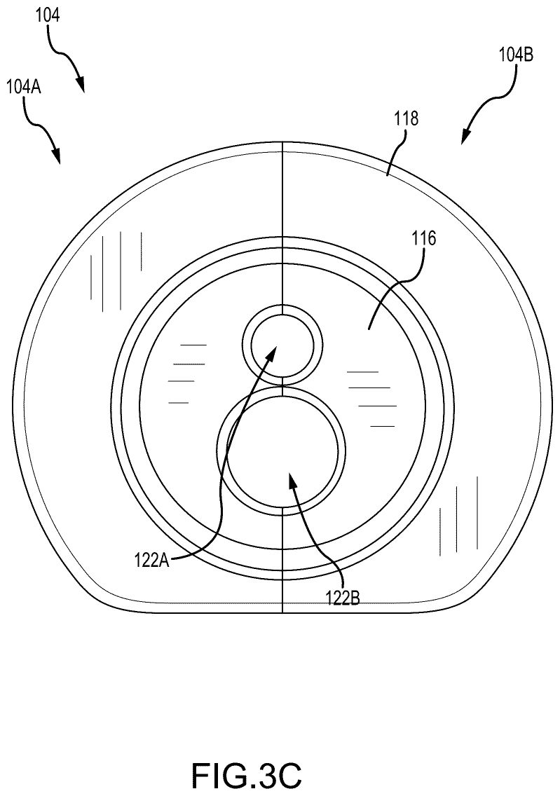

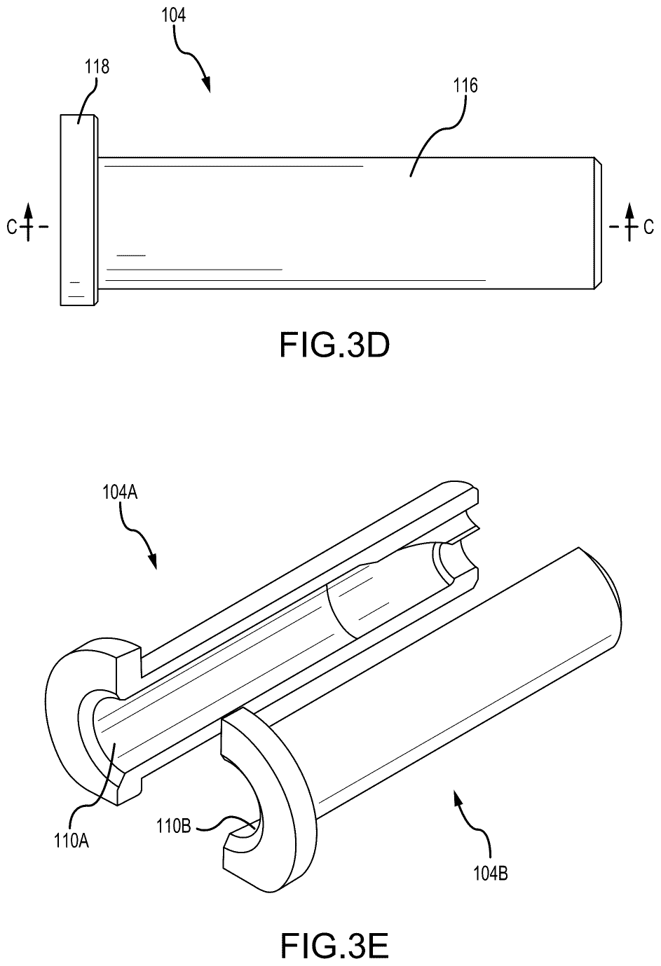

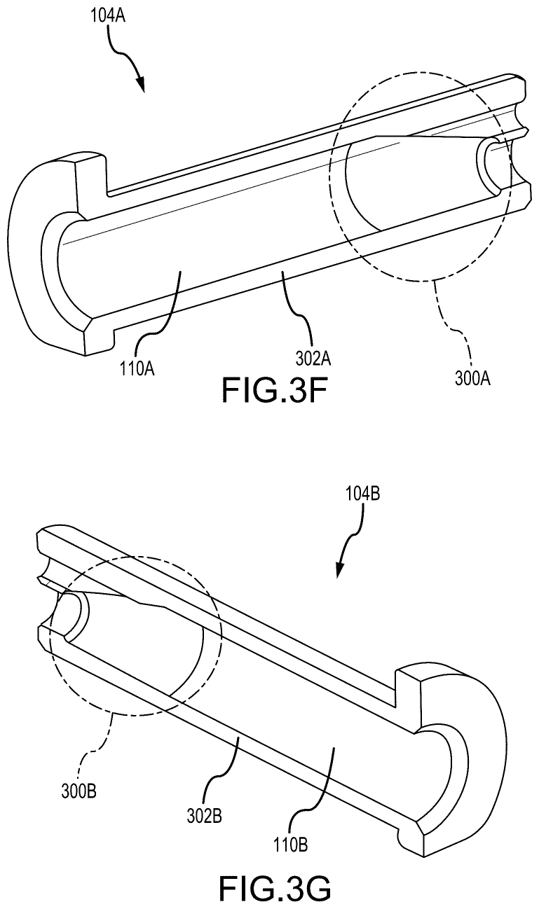

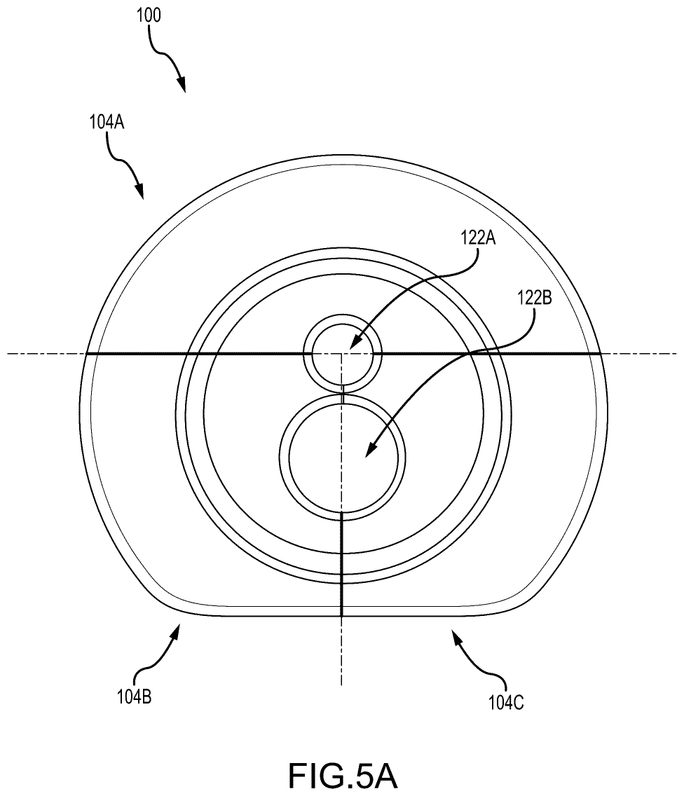

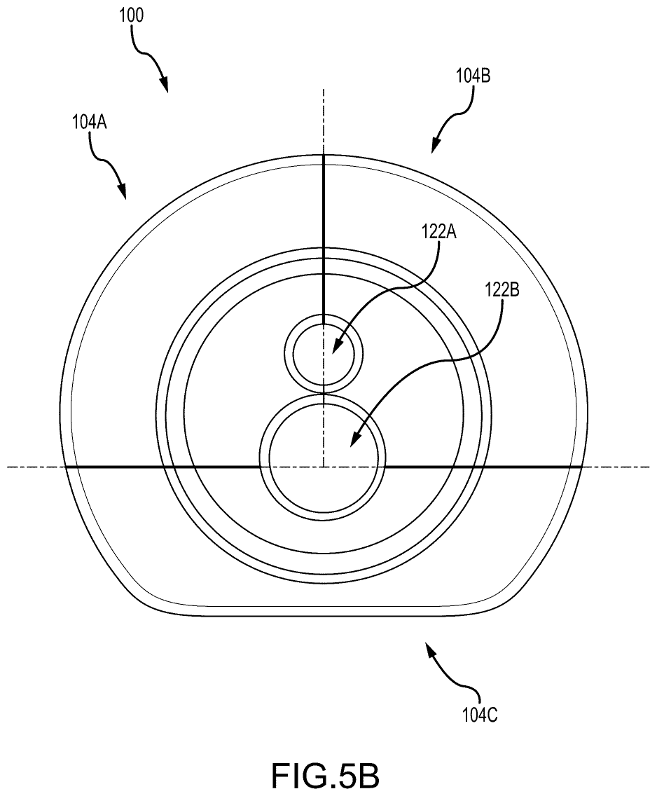

The inner component 104 may be one component or split into at least two subcomponents. In the example shown, there are two subcomponents 104A and 104B (FIG. 1F), but it is to be understood that there may be additional subcomponents, for example three subcomponents 104A, 104B, and 104C as shown in FIGS. 5A and 5B, or more subcomponents as suitable. The subcomponents 104A and 104B are coupled together to form the inner components 104 and to define the second inner cavity 108 when coupled. In some examples, referring to FIGS. 3F and 3G, “coupling” may indicate that the configuration of an interface surface 302A of the subcomponent 104A substantially matches the configuration of an interface surface 302B of the subcomponent 104B. In some examples, the subcomponents 104A and 104B may be formed by cutting or splitting a premade inner component 104 into separate subcomponents, such as by cutting the inner component 104 in a planar direction substantially along a longitudinal axis of the inner component 104.

Alternatively, the inner component 104 may be a unitary piece formed of a single component (that is, not split into two or more subcomponents) such that the inner component 104 is disposed in the first inner cavity 106 as a single unitary piece, as shown in FIG. 1G. Numerous possible benefits or advantages may be provided by implementing a single unitary piece as the inner component 104.

For example, a unitary piece may be preferred or beneficial for the inner component 104 so as to reduce or eliminate the amount of flash or polymer flow within the seams or interface surfaces 302A and 302B at which the subcomponents 104A and 104B would mate or couple, as shown in FIGS. 3F and 3G as mentioned above. Injection molding flash is a defect that occurs when molten polymer such as plastic flows out of the mold during injection and solidifies. Even with a tight fitment tolerance between the two subcomponents 104A and 104B, excessive flash can be observed in some examples. In some cases, the machining/fabrication process for the unitary piece design for the inner component 104 may be easier to achieve than the multi-piece design due to the complex geometry within the cavity.

Furthermore, in examples where the tolerances required are tight due to the product specification related to the mold, it may be challenging or difficult to form the multiple subcomponents from their respective drawings with discrete tolerances that create a cavity with an expected fit when mated or coupled together to form the inner component 104, as compared to making the inner component 104 as a unitary piece whose features fell onto only one design drawing or tolerance requirement, since it may be difficult to produce a complex cavity with said tight tolerances for such multi-piece designs.

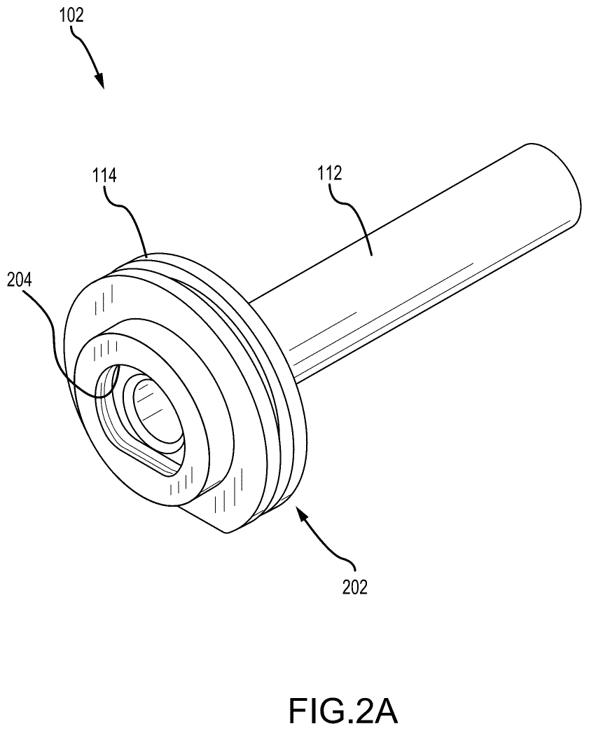

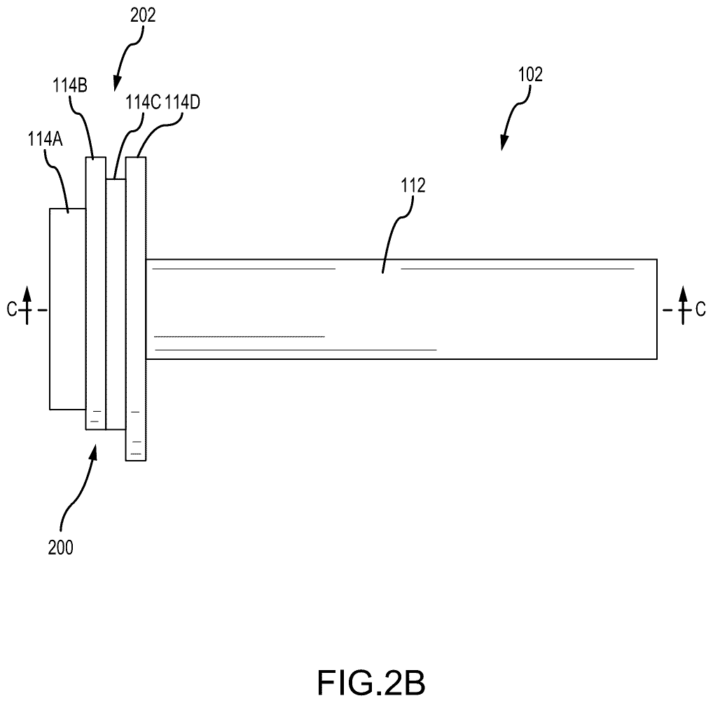

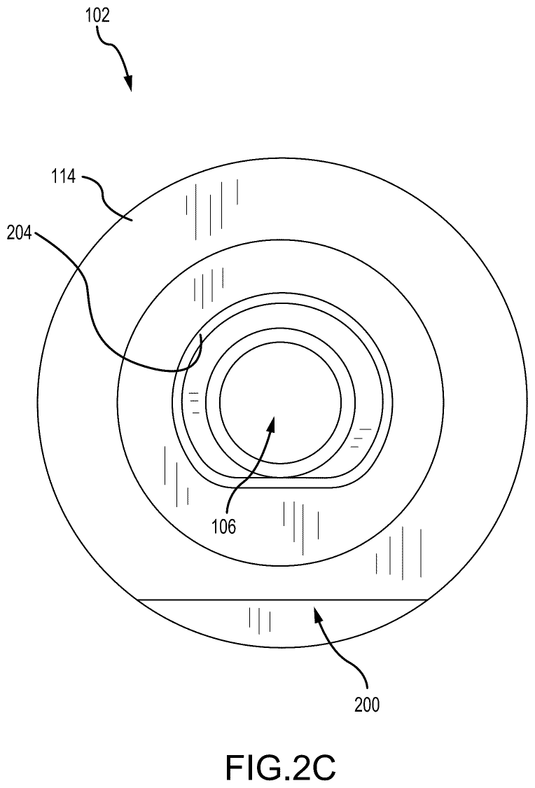

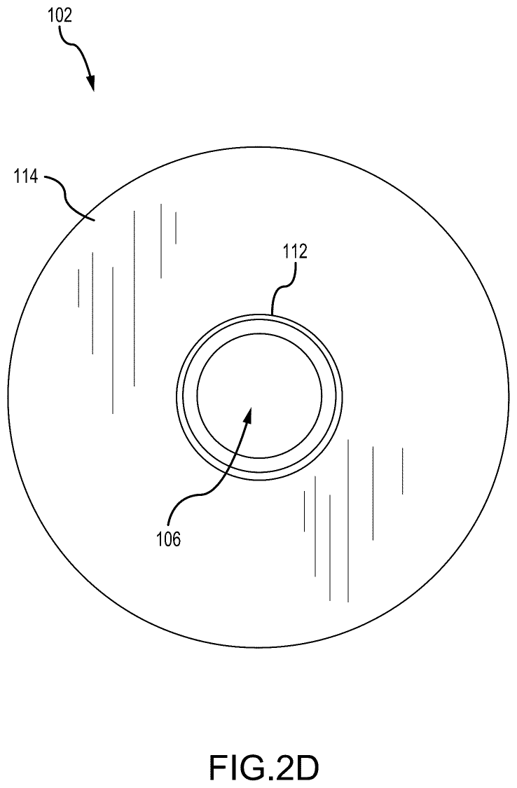

Referring to FIGS. 2A through 2D, the outer component 102 is shown to include an outer elongate portion 112 and an outer flange portion 114 extending radially outwardly from the outer elongate portion. The radial direction may be the direction that is substantially perpendicular with respect to a central longitudinal axis C-C of the outer component 102 (FIG. 2B). In some examples, the outer flange portion 114 includes a plurality of flanges. The flanges may extend for different distances from the central axis C-C. For example, the outer flange portion 114 in the example as shown may be subdivided into four flanges 114A, 114B, 114C, and 114D. This is for illustrative purposes, and it is to be understood that any number of flanges may be formed as suitable. Among the four identified flanges, as shown, the flange 114A generally extends the shortest distance radially from the central axis C-C, while the flanges 114B and 114D extend the longest distance. The distance may be measured in terms of the greatest distance that is measured for the flange or in terms of the average distance that is calculated for the flange.

In some examples, one or more of the flanges may have a cut portion 200 (FIG. 2B) which is a portion of the flange that extends less radially outwardly than other flanges or other portions of the flange. In the example shown, the flange 114B includes the cut portion 200, which may be formed for any purposes such as allowing the outer component 102 to be correctly aligned or positioned with respect to the housing or for allowing airflow between the flanges, for example. The flanges 114B and 114D extend longer distances than does the flange 114C which is disposed between the flanges 114B and 114D. These three flanges 114B through 114D may form a spool 202 having a central portion defined by the shorter flange 114C with two rims or ridges defined by the longer flanges 114B and 114D.

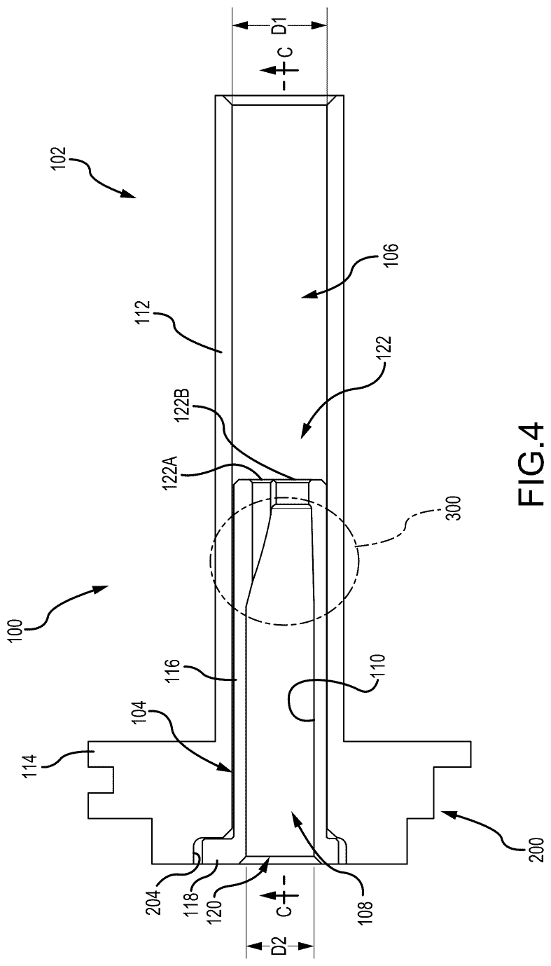

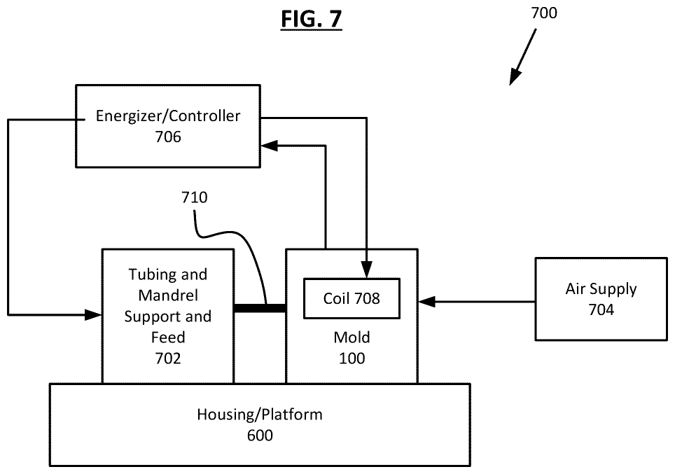

The spool 202 may be configured to support a coil 708 (in FIG. 7) which may be wrapped around the shorter flange 114C between the longer flanges 114B and 114D. The coil 708 may be made of any suitable material that allows for the receipt of electrical energy to inductively generate heat for heating the mold 100. In some examples, the outer component 102 is formed of a single unitary piece of material for efficient assembly. In other examples, the outer component 102 is formed by assembling together multiple, separate components. In some examples, the flange portion 114 of the outer component 102 includes a depression 204 which receives the flange portion 118 of the inner component 104 to limit how much the inner component 104 may be inserted into the first inner cavity 106 of the outer component 102 (FIG. 4).

Referring to FIGS. 3A through 3G, a multi-piece inner component 104 includes an inner elongate portion 116 and an inner flange portion 118 extending radially outwardly from the inner elongate portion 116. The radial direction may be the direction that is substantially perpendicular with respect to a central longitudinal axis C-C(FIG. 4) of the inner component 104. For example, as shown in FIG. 4, the central longitudinal axis C-C may be common to both the outer component 102 and the inner component 104 when the two components 102, 104 are concentric. In some examples, the flange portion 118 may include the cut portion 200 to assist in aligning the inner component 104 with respect to the outer component 102.

The inner component 104 includes the second inner cavity 108 such that the cavity 108 extends between a first end 120 and a second end 122. The first end 120 may be defined by one opening, and the second end 122 may have a plurality of openings, for example two openings 122A and 122B as shown. In some examples, there may be three or more openings at the second end 122 of the second inner cavity 108. In some examples, the single opening at the first end 120 may have a larger diameter than any one of the multiple openings at the second end 122. In some examples, the multiple openings at the second end 122 have various different sizes. For example, the second or bottom opening 122B has a larger diameter than the first or top opening 122A, and both openings 122A and 122B are smaller in diameter and size than the single opening at the first end 120.

The configuration of the cavity 108 is defined by the inner surface 110 of the inner component 104, which may be separated into two (or more) inner surfaces 110A (FIG. 3F) and 110B (FIG. 3G), where each separate inner surface defines a portion of the cavity 108 and a portion of each of the openings of the first end 120 and the second end 122. For example, FIGS. 3B and 3C show the separation of the two subcomponents 104A and 104B as shown by the black line extending vertically down the middle of the inner component 104 such that the left half of the opening on the first end 120 and of the openings (122A and 122B) on the second end 122 belong to the subcomponent 104A while the other half of these openings belong to the other subcomponent 104B.

As shown in FIG. 4, in some examples, the inner surface 110 of the inner component 104 includes a transition portion 300 which transitions in diameter between the first end 120 and the second end 122 of the second inner cavity 108. The transition portion 300 may be separated into two transition portions 300A (FIG. 3F) and 300B (FIG. 3G) in the subcomponents 104A and 104B, respectively. The transition portion 300 may define a transition of the inner cavity 108 from a first configuration defined by the first end 120 to a second configuration defined by the second end 122. The first configuration may include a single substantially tubular cavity, where the diameter of the cavity remains substantially the same. The second configuration may include two (or more) substantially tubular cavities, where the diameters of the cavities are smaller than the diameter of the single tubular cavity of the first configuration. In some examples, the transition portion 300 includes a taper. The taper may define a reduction in the larger diameter of the single cavity of the first configuration toward the smaller diameter of one of the cavities of the second configuration, and the remaining cavity (or cavities) of the second configuration may extend from the taper as shown in FIG. 4.

Referring to FIGS. 5A and 5B, the inner component 104 includes three subcomponents 104A, 104B, and 104C, where the subcomponents may be separated in two different configurations. In the first configuration shown in FIG. 5A, the separation causes the opening 122A to be defined by all three of the subcomponents 104A, 104B, and 104C, while the opening 122B is defined by two subcomponents 104B and 104C. Alternatively, in the second configuration shown in FIG. 5B, the opening 122B is defined by all three of the subcomponents 104A, 104B, and 104C, while the opening 122A is defined by two subcomponents 104A and 104B. In some examples, the number of subcomponents may be greater than three, in which case the openings 122A and 122B may be defined by more subcomponents as suitable.

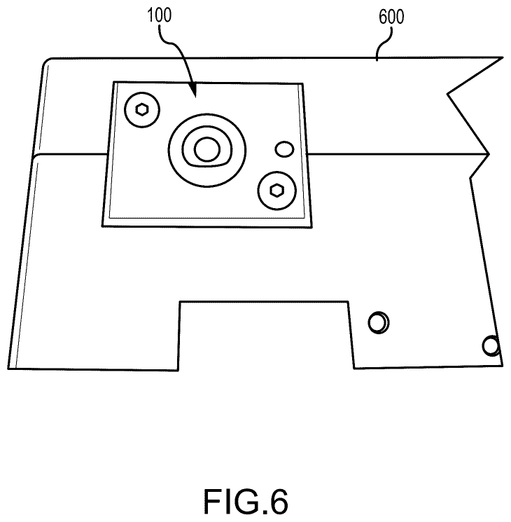

Referring to FIGS. 6 and 7, a housing 600 is shown with the mold 100 implemented therein. The housing 600 may also be referred to as a platform which supports the mold 100 in a mold apparatus 700 which is operable to mold (e.g., form, weld, or shape a tubing), which may be an intravenous (IV) tubing made of a polymeric or thermoplastic material. The mold 100 may be mounted, attached, affixed, or otherwise coupled to the housing 600 using any suitable means such as screws. The apparatus 700 includes a support and feed unit 702 which is supported by the housing 600 and is configured to insert and withdraw a mandrel 710 supporting a tubing into and from the mold 100. The apparatus 700 includes an air supply unit 704 which provides air for cooling the mold. The apparatus 700 includes an energizer or controller 706 which controls operation of the support and feed unit 702 and to supply energy for heating the mold 100.

In some examples, the insertion and withdrawal of the mandrel 710, along with insertion and withdrawal of tubing to be molded, into and from the mold 100 is provided by the support and feed unit 702. The unit 702 may also support the mandrel 710 prior to and after insertion into the mold 100. The air for mold cooling purposes is provided by the air supply 704 conveying air under pressure, for example through a lumen, to the mold 100. The energizer/controller 706 may be a radiofrequency (RF) generator and control circuit, and may be operably connected to the support and feed unit 702, for example through conductor(s). The signals transmitted by the controller 706 may control the transport of the mandrel-supported tubing into the mold 100, the duration the tubing is within the mold 100, and the withdrawal of the tubing. RF energy may be supplied to the coil 708 coupled with the spool 202 of the mold 100 to cause the coil 708 to inductively heat the mold 100. Additional conductor(s) may be implemented to provide feedback signals from the mold 100 to the controller 706. Such feedback signals may be of many types, including temperature indication at one or more locations, signals reflective of the position of one or more of the moveable components, and signals reflective of the air flow rate and/or temperature.

In contrast to unitary mold designs (i.e., where the inner cavity is defined by a single unitary component), the split or modular approach described herein permits full coating of the inner cavity. For example, in unitary mold designs, coating methods are applied from an end portion of the cavity allowing for the ends of the cavity to be coated, but penetration to the intermediate section (or middle portion) is limited and may prevent the intermediate section of the cavity to be properly coated, or at the very least causing considerable difficulty in effective coating. This can be particularly true due to the small size or diameter of the cavity, which may be less than 3 mm, less than 1 mm, less than 0.5 mm, less than 0.3 mm, or less than 0.1 mm in diameter, depending on the size of the tubing or catheter that is to be formed using the cavity. This is especially problematic considering the length of the cavity, which may be from 1 cm to 1.5 cm, from 1.5 cm to 2 cm, from 2 cm to 2.5 cm, from 2.5 cm to 3 cm, from 3 cm to 4 cm, from 4 cm to 5 cm, or any other suitable range therebetween or combination thereof. In some cases, only a fraction (for example, less than 10%) of the entire cavity may be properly coated, whereas the modular, or split mold designs described herein promote ease of coating. In unitary designs, there may also be a problem that, in an attempt to coat as much of the intermediate section or middle portion of the cavity as possible, too much coating may be applied to the end portions, which may cause the end portions of the cavity to have a narrower opening size or diameter as compared to the intermediate section or middle portion. Properly coating the entirety of the cavity is advantageous to process performance, for example in the case of low friction coatings, and because the coating provides protection such that the wall of the cavity may degrade over time from continuous abrasion or any other factors.

Therefore, having the subcomponents 104A and 104B (and in some examples, also 104C as well as any additional subcomponents as suitable) as disclosed herein beneficially improves the coating process of the second inner cavity 108 (or more specifically, the inner surface 110 which defines the cavity 108) by allowing the entirety of the inner surface 110 to be properly coated. Beneficially, the mold 100 is also replaceable, or more specifically, the inner component 104 may be removed and replaced without having to remove the outer component 102 from the housing 600, such that when the coating degrades in the inner component 104, a separate, new inner component 104 with a newly coated cavity 108 may replace the old inner component 104 and continue the operation of the mold apparatus 700 for a quick swapping of the inner component 104 without having to replace the entire mold with a new mold.

For example, prior to coupling together to define the second inner cavity 108, the inner surfaces 110A and 110B of the subcomponents 104A and 104B of the inner component 104 are separately and individually coated with a coating material using an appropriate process. The coating material as referred to herein may be any suitable coating, for example including but not limited to one or more of: metal nitrides, silicone-based materials, polytetrafluoroethylene (PTFE) coatings including derivatives thereof, and/or diamond-like-coatings (DLC) including derivatives thereof, among others. Examples of metal nitrides may include but are not limited to: titanium nitride (TiN), titanium carbo-nitride (TiCN), titanium aluminum carbo-nitride (TiAICN), zirconium nitride (ZrN), chromium nitride (CrN), aluminum titanium nitride (AITIN), and/or aluminum chromium nitride (AICrN), among others. Examples of silicone-based materials may include but are not limited to materials that are cross-linked from polysiloxane and/or polyzilazane, among others.

Methods of coating as implemented herein may include, but are not limited to, any one or more of the following: physical vapor deposition (PVD), chemical vapor deposition (CVD), sputtering, thermal evaporation, carbon coating, electron beam evaporation (EBE), molecular beam epitaxy (MBE), pulsed laser deposition (PLD), ion beam deposition (IBD), and/or any other suitable methods or techniques of coating applications as known in the art, such as other thin-film coating techniques. In some examples, the coating that is applied may be a liquid coating or any suitable form of coating mixture or solution which may be applied directly on the surfaces as explained above, including but not limited to spray coating and/or dip coating, among others. It is to be understood that the coating methods or applications as implemented herein are not limited to those that are disclosed herein, and that different methods of coating may be employed for different types of coating as explained above, and/or to achieve different properties or characteristics.

Different coatings may offer different properties, characteristics, and/or applications. For example, metal-nitrides may be used for forming of medical tools including plastic molding, providing high hardness, increased abrasive wear resistance, and enhanced toughness for the product. Additionally they may provide wear and corrosion resistance, oxidation resistance. Silicone-based and PTFE-based coating materials may provide low friction and/or low adhesion. In some examples, such coating may further provide corrosive, oxidative, and/or abrasive resistance. The different coating materials may also have different levels or values of microhardness, friction coefficient, and thermal threshold. The coating materials may also be biocompatible. As such, different coating materials may be used in conjunction with different materials that form the tubing or the inner surface 110 of the inner component 104, based on the needs or requirements of the application. In some examples, multiple layers of coating of the same or different materials may be applied to increase certain properties or provide additional properties for the material that is coated.

Materials used to form the inner component 104 (and the subcomponents) may include any suitable metal including but not limited to one or more of: stainless steel, nitrogen-enhanced duplex stainless steel, molybdenum-type high-speed steel, nickel, or nickel-iron alloy. The stainless steel may include various alloys, for example, 420 and 440C stainless steels. The nitrogen-enhanced duplex stainless steel may include, for example, Duplex 2205 stainless steel. The molybdenum-type high-speed steel may include, for example, tungsten-molybdenum high-speed steel such as M2 steel. The nickel-iron alloy may include, for example, an 80% nickel-iron-molybdenum alloy such as HyMu 80.

The above lists of material are not exhaustive, and any other suitable type of material may be implemented as suitable for the application. The mold 100 may be used in any suitable catheter tip forming machine and/or any suitable catheter manufacturing machine including but not limited to the Vante SAFFIRE® system, the Vante RUBY® system, Vante Jade® system, etc., as well as any other type of tip forming machine implementing RF inductive coil heating capabilities.

The disclosure of this application has been described above both generically and with regard to specific embodiments. It will be apparent to those skilled in the art that various combination, modifications, and variations can be made in the embodiments without departing from the scope of the disclosure. Thus, it is intended that the embodiments cover the combination, modifications, and variations of this disclosure provided they come within the scope of the appended claims and their equivalents.

1. A mold for an apparatus for forming a polymeric product, the mold comprising:
an outer component defining a first inner cavity having a first diameter; and
an inner component configured to be disposed at least partially inside the first inner cavity of the outer component, the inner component having an inner surface which defines a second inner cavity having a second diameter smaller than the first diameter, the inner component being a single unitary piece comprising an inner surface that defines the second inner cavity for receiving a polymeric material during molding of the polymeric product.

2. The mold of claim 1, the outer component comprising an outer elongate portion and an outer flange portion extending radially outwardly from the outer elongate portion.

3. The mold of claim 2, the inner component comprising an inner elongate portion and an inner flange portion extending radially outwardly from the inner elongate portion.

4. A mold for an apparatus for forming a polymeric product, the mold comprising:
an outer component defining a first inner cavity having a first diameter; and
an inner component configured to be disposed at least partially inside the first inner cavity of the outer component, the inner component having an inner surface which defines a second inner cavity having a second diameter smaller than the first diameter, the inner component comprising:
a first subcomponent having a first inner surface; and
a second subcomponent having a second inner surface,
wherein the first and second subcomponents are configured to couple together, and the first and second inner surfaces are configured to define the second inner cavity for receiving a polymeric material during molding of the polymeric product.

5. The mold of claim 4, the inner component further comprising a third subcomponent having a third inner surface, wherein the first, second, and third subcomponents are configured to couple together, and the first, second, and third inner surfaces are configured to define the second inner cavity.

6. The mold of claim 5, wherein, prior to coupling together to define the second inner cavity, the inner surfaces of the subcomponents of the inner component are separately and individually coated with a coating material.

7. The mold of claim 6, wherein the coating material includes one or more of:
titanium nitride, titanium carbo-nitride, titanium aluminum carbo-nitride, zirconium nitride, chromium nitride, aluminum titanium nitride, aluminum chromium and silicon, or aluminum chromium nitride.

8. The mold of claim 4, the outer component comprising an outer elongate portion and an outer flange portion extending radially outwardly from the outer elongate portion.

9. The mold of claim 8, wherein the outer flange portion includes a plurality of flanges, and at least one of the flanges includes a cut portion which extends less radially outwardly than other flanges.

10. The mold of claim 9, wherein the plurality of flanges form a spool configured to support a coil for inductively heating the mold.

11. The mold of claim 8, the inner component comprising an inner elongate portion and an inner flange portion extending radially outwardly from the inner elongate portion.

12. The mold of claim 4, wherein the second inner cavity has a first end having one opening and a second end having a plurality of openings.

13. The mold of claim 12, wherein the one opening at the first end of the second inner cavity has a larger diameter than any one of the plurality of openings at the second end.

14. The mold of claim 12, wherein the plurality of openings at the second end have different diameters.

15. The mold of claim 12, wherein the inner surface of the inner component includes a transition portion configured to transition in diameter between the first end and the second end of the second inner cavity.

16. The mold of claim 15, wherein the transition portion includes a taper.

17. The mold of claim 4, wherein at least one of the outer component or the inner component is made of one or more of: stainless steel, nitrogen-enhanced duplex stainless steel, molybdenum-type high-speed steel, nickel, or nickel-iron alloy.

18. A mold apparatus for forming a tubing, the apparatus comprising:
the mold of claim 1;
a housing configured to securely support the mold;
a support and feed unit supported by the housing and configured to insert and withdraw a mandrel supporting the tubing into and from the mold;
an air supply unit configured to provide air for cooling the mold; and
a controller configured to control operation of the support and feed unit and to supply energy for heating the mold.

19. A method of forming a mold for an apparatus for forming a polymeric product, the method comprising:
coating a first inner surface of a first subcomponent;
coating a second inner surface of a second subcomponent;
forming an inner component by coupling the first subcomponent with the second subcomponent to define a second inner cavity for receiving a polymeric material during molding of the polymeric product; and
at least partially disposing the inner component inside a first inner cavity of an outer component.

20. The method of claim 19, wherein coating the first and second inner surfaces includes applying a coating material to the first and second inner surfaces.
